(19) United States
(12) Patent Application Publication
(10) Pub. No.: US 2005/0070195 A1
(43) Pub. Date: Mar. 31, 2005

(54) Method for providing a glass panel of a color display tube with suspension pins

(76) Inventor: Gerardus Wilhelmus Maria Theelen, Eindhoven (NL)

Correspondence Address: Philips Electronics North America Corporation;Corporate Patent Counsel, PO Box 3001, Briarcliff Manor, NY, 10510, US

(21) Appl. No.: 10/498,758

(22) PCT Filed: Nov. 16, 2002
(86) PCT No.: PCT/IB02/05463

(30) Foreign Application Priority Data
Dec. 20, 2001 (EP) 01205051.4

(51) Int. Cl. H01J 9/00; H01J 9/24

(52) U.S. Cl. 445/24

(57) ABSTRACT

The invention relates to a method for providing a glass panel (2) of a color display tube (1) with suspension pins (24) for suspending a mask box (22) in a nominal position from said panel (2), the mask box (22) comprising resilient suspension elements (21). Firstly, suspension pin bases (26) are positioned on an inner surface of the panel (2) and subsequently attached to the panel inner surface by melting them in. Secondly, suspension pin heads (25) are positioned on the suspension pin bases (26) and subsequently attached to the suspension pin bases≈(26). In the process, the positioning of the suspension pin bases (26) as well as the suspension pin heads (25) is performed with respect to a panel positioning device (35) comprising positioning points. In particular, the suspension pin heads (25)′ are brought into a nominal receiving path which is described by a nominal receiving part of a nominal resilient suspension element (21).

The present invention relates to a method for providing a glass panel of a color display tube with suspension pins for suspending a mask box in a nominal position from said panel, the suspension pins comprising: a suspension pin head which is suitable for being at least partly received by a receiving part of a resilient suspension element of the mask box to be suspended; and a suspension pin base for connecting the suspension pin head to an inner surface of the panel, the suspension pin base having a supporting surface for supporting the suspension pin head; the method comprising the following steps: placing the panel onto a panel positioning device comprising positioning points; positioning at least three suspension pin bases nominally with respect to the positioning points; attaching the suspension pin bases to the panel inner surface; placing the suspension pin heads onto the supporting surfaces of the suspension pin bases; and attaching the suspension pin heads to the suspension pin bases.

In the above as well as in the following, being nominal is defined as being within pre determined ranges of an exact pre-determined value or set of values.

A method for providing a glass panel with suspension pins is well-known in practice, and is part of a color display tube manufacturing method.

It is well-known that a color display tube comprises a panel-mask box combination, wherein a mask box is suspended from a panel. The panel is made of glass and comprises a substantially rectangular display window provided with an upright edge. The mask box comprises a substantially rectangular mask blank having a large number of apertures. Furthermore, the mask box comprises a frame that is attached to an upright edge of the mask blank, the frame comprising frame parts, interconnecting parts and resilient suspension elements.

It is very important that the mask blank is suspended from the display window in a proper position. In fact, the window-to-mask distance is a determining factor in the performance of the color display tube. As the positions of the suspension pins directly determine the position of the mask blank, the panel must be accurately provided with the suspension pins. Therefore, the suspension pin bases are attached to the panel inner surface while the panel is placed onto a panel positioning device comprising a number of positioning points. The positions of the suspension pin bases are determined with respect to the positioning points. In this way, possible deviations in the positions of the suspension pin bases resulting from differences in panel layout are avoided.

According to the known method, the position of the suspension pin heads, which are intended for cooperation with the resilient suspension elements of the mask box, is determined by the position of the suspension pin bases. The reason for this is that the suspension pin heads are usually positioned at the center of the supporting surfaces. Thus, the accuracy with which the suspension pin bases are positioned determines the accuracy of the positioning of the suspension pin heads and hence the accuracy of the positioning of the suspension pins as a whole.

In the known method a positioning accuracy of the suspension pins of ±0.6 mm can be achieved in practice. The relatively large deviations in the positions of the suspension pins are the basis for certain drawbacks, a number which shall be described below.

The color display tube manufacturing method comprises a photographic process of providing a display screen on the display window of the panel, in which the mask blank is utilized. For this purpose, repeated mounting and demounting of the mask box is necessary. In this process, the insertion reproducibility, i.e. the degree of reproducibility of the position of the mask blank is very important, taking into account an allowed deviation of less than 2 μm. Therefore, it is highly desirable that during mounting no deformations occur in the elements of the mask box, except for a reproducible deformation of the resilient suspension elements.

As regards suspending a mask box from a panel provided with suspension pins according to the known method, the relatively large deviations in the positions of the suspension pins are compensated for to a sufficient extent by a deformation of the resilient suspension elements of the mask box. In this way, it is actually possible to suspend the mask box from the panel in a proper position. However, in many cases, the deviations don't only cause a deformation in the resilient suspension elements, but also an undesired deformation in the frame parts, the interconnecting parts or the mask blank. Due to this, the insertion reproducibility often is affected in such a way that at the end of the photographic process a useless display screen is obtained. The display screen then has to be taken off the panel and the photographic process has to be started all over again. It will be understood that this is an important drawback, resulting inter alia in an increase of manufacturing costs of the color display tube.

Another drawback that results from providing the panel with suspension pins utilizing the known method is that a mask box can only be adapted for cooperation with one specific panel. Initially, the receiving parts of the resilient suspension elements are slidable with respect to base parts of the resilient suspension elements. During a first suspension of the mask box from a specific panel, the receiving parts are forced into certain positions by the suspension pin heads of that panel. Subsequently, the receiving parts are fixed with respect to the base parts. As a result, the mask box fits into that specific panel, and cannot be suspended from another panel any more, since the positions of the suspension pin heads of another panel deviate too much from the positions of the suspension pin heads of the specific panel. So once the receiving parts are fixed with respect to the base parts, the mask box is assigned to a specific panel. As a consequence, pairs of mask boxes and panels have to be kept together not only during the photographic process, but also before that process, i.e. from the time the receiving parts have been fixed with respect to the base parts. Besides, when the panel is lost during the manufacturing process, for whatever reason, also the mask box cannot be used any more.

Generally, the receiving parts are fixed with respect to the base parts by welding. The welding process is performed while the mask box is suspended from the panel, the suspension pin heads of the panel retaining the receiving parts. During the welding process, welding spatter may fall on the panel inner surface, which is undesirable of course.

In the following, a nominal resilient suspension element is defined as a resilient suspension element which is positioned nominally with respect to the positioning points and which springs according to a nominal spring characteristic; and a nominal receiving part is defined as a receiving part which is positioned nominally on the nominal resilient suspension element.

It is an object of the present invention to overcome at least one of the drawbacks of the known method for providing a glass panel with suspension pins. Said object is achieved by bringing the suspension pin heads into nominal positions with respect to the positioning points before the suspension pin heads are attached to the suspension pin bases. In particular, each suspension pin head is brought into a nominal receiving path which is described by a nominal receiving part.

According to the present invention, the suspension pin heads are positioned with respect to the positioning points of the panel positioning device, whereas according to the state of the art, the suspension pin heads are positioned with respect to the suspension pin bases.

An important advantage of the present invention is that the suspension pin heads can be brought into a nominal position, in spite of relatively large deviations in the position of the suspension pin bases. The position of each suspension pin head may partially be determined by the position of the supporting surface of the assigned suspension pin base, but the suspension pin head can still be brought into the nominal position. The reason for this is that the nominal receiving path covers a sufficiently large range of possible positions, wherein it is always possible to position a suspension pin head on the supporting surface as well as in the nominal receiving path.

By positioning the suspension pin heads in the nominal receiving path, the insertion reproducibility is enormously increased. This is a result of the positions of the suspension pin heads being so well adapted to the layout of the mask box that only a reproducible deformation of the resilient suspension elements will occur during suspending the mask box from the panel.

If the method according to the invention is applied, the suspension pin heads are positioned nominally, enabling an accuracy of at least ±25 μm to be achieved for the positions of the suspension pin heads. As a result, it is possible to exchange mask boxes and panels in the manufacturing process prior to the photographic process, without any fitting problems. It is also possible to use one panel as a jig, wherein mask boxes that can suitably be fitted into the panels are obtained by welding the receiving parts of the resilient suspension elements to the base parts. In that case, all panels other than the one that serves as a jig will be free from welding spatter.

The present invention also relates to a method for positioning a suspension pin head onto a suspension pin base, to a method for manufacturing a series of at least two substantially identical mask boxes, to a method for manufacturing a series of at least two panel-mask box combinations, and to a dummy mask box.

The invention will now be explained in greater detail with reference to the figures, in which similar parts are indicated by the same reference signs, and in which:

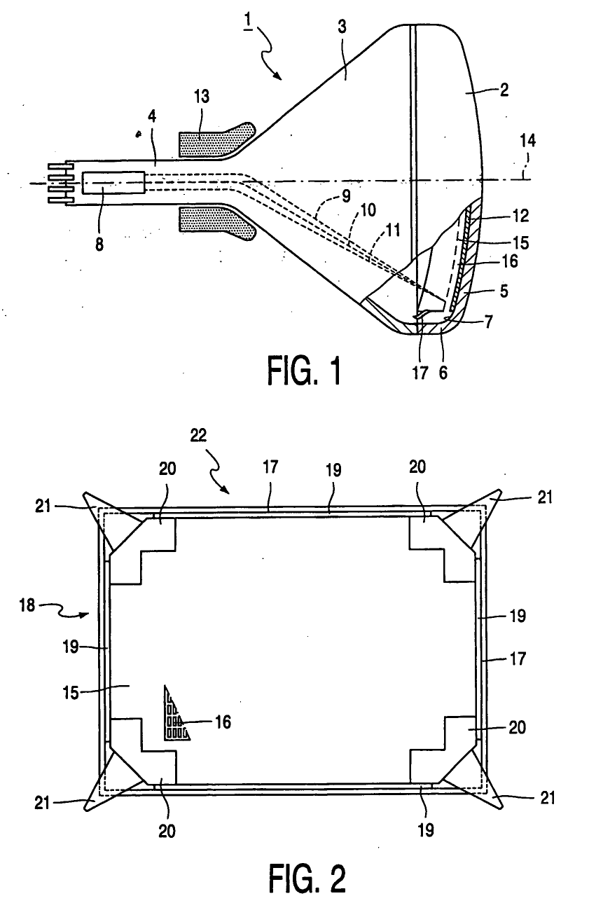

FIG. 1 is a partial sectional view of a color display tube;

FIG. 2 is a rear view of a mask box that is part of the color display tube as shown in FIG. 1;

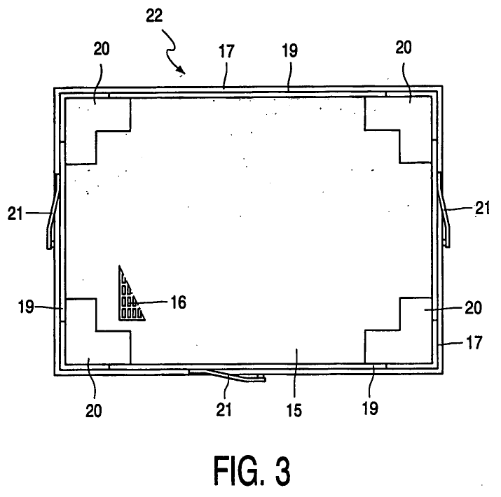

FIG. 3 is a rear view of an alternative mask box;

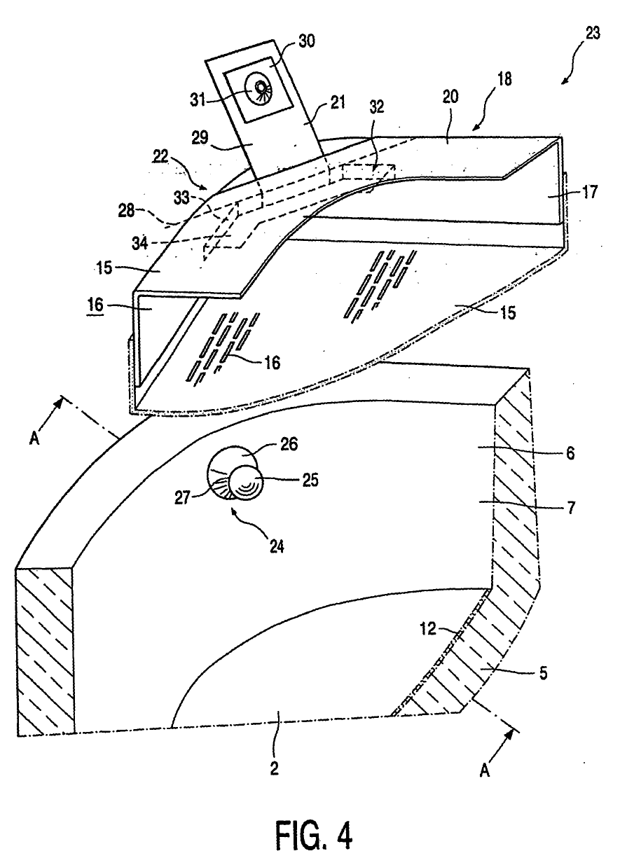

FIG. 4 is an exploded perspective view of a corner part of a panel-mask box combination that is part of the color display tube as shown in FIG. 1;

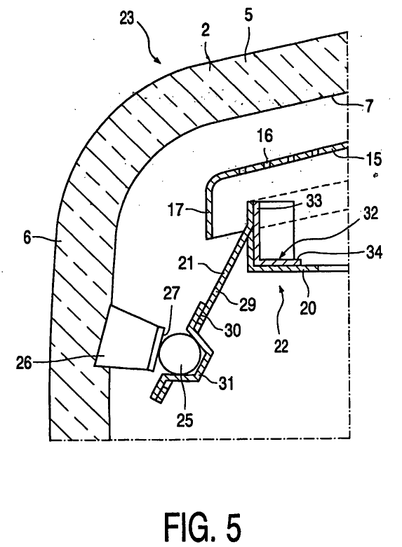

FIG. 5 is a sectional view taken on the line A-A of FIG. 4;

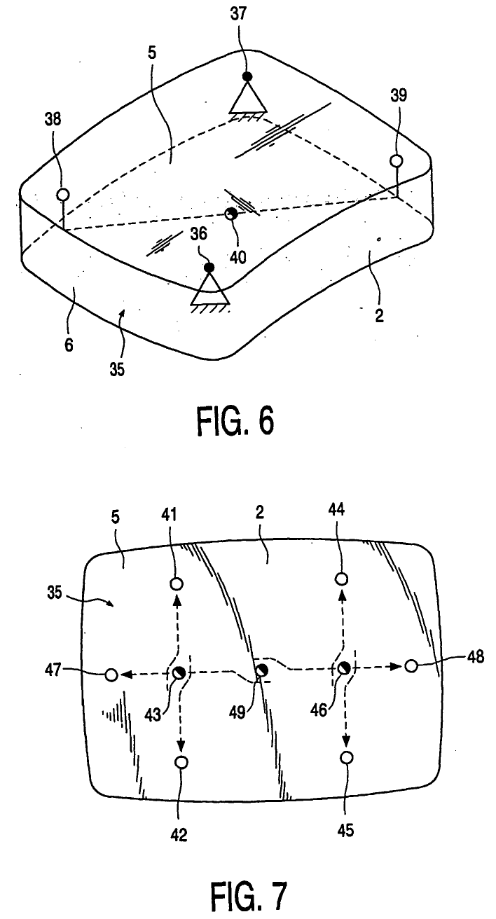

FIG. 6 is a diagrammatic view of a panel placed on a panel positioning device;

FIG. 7 is another diagrammatic view of a panel placed on the panel positioning device as shown in FIG. 6;

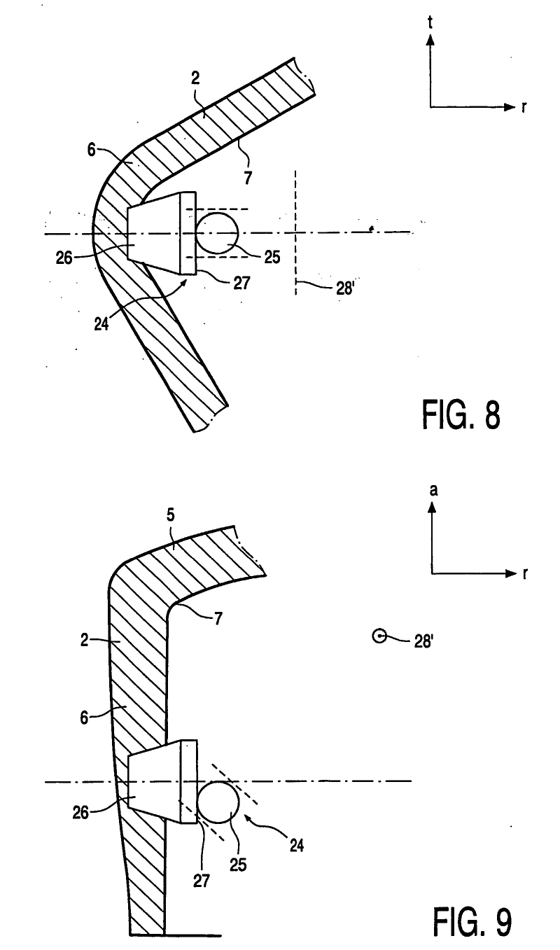

FIG. 8 diagrammatically shows a cross section of a portion of the panel as shown in FIGS. 6 and 7, the portion being provided with a suspension pin;

FIG. 9 diagrammatically shows a longitudinal section of the portion of the panel as shown in FIG. 8;

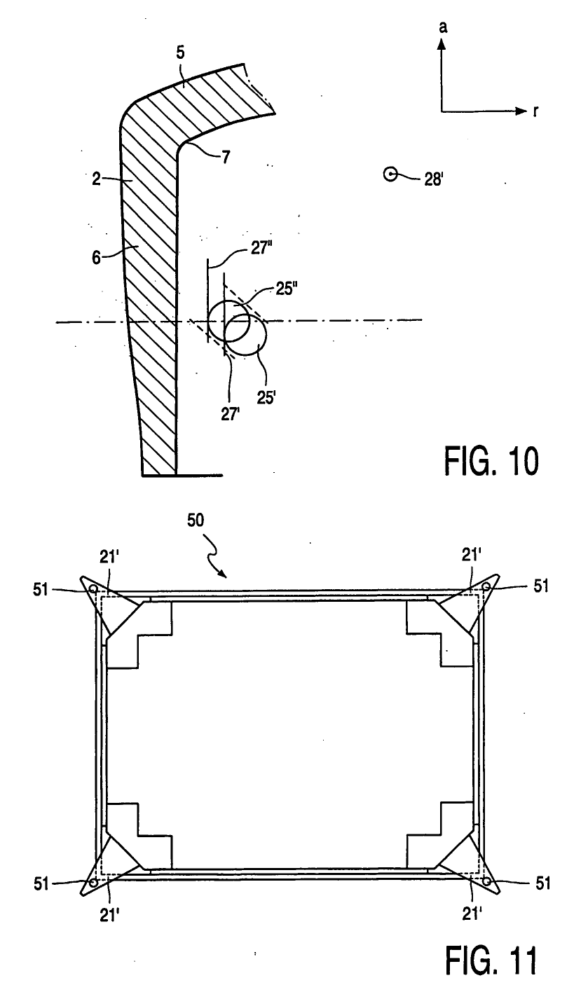

FIG. 10 again shows the longitudinal section as shown in FIG. 9; and

FIG. 11 is a rear view of a dummy mask box.

FIG. 1 is a longitudinal sectional side view of a color display tube 1 comprising a glass envelope having a panel 2, a cone 3 and a neck 4. The panel 2 comprises a substantially rectangular display window 5 and an upright edge 6. An inner surface of the panel 2 is indicated by means of reference numeral 7. The neck 4 accommodates an electrode system 8 having three electron guns for generating three electron beams 9, 10, 11. The electron beams 9, 10, 11 are directed towards a display screen 12 which is provided on the inside of the display window 5 and which comprises a large number of red, green and blue luminescing phosphor elements. On their way to the display screen 12, the electron beams 9, 10, 11 are deflected by deflection coils 13 which are coaxially arranged about a longitudinal axis 14 of the color display tube 1. Furthermore, the electron beams 9, 10, 11 pass through a mask blank 15 having apertures 16. The three electron beams 9, 10, 11 pass through the apertures 16 at a small angle with each other and, consequently, they are each incident on phosphor elements of one color.

Referring now to FIGS. 2 and 3, an upright edge 17 of the mask blank 15 is secured to a frame 18 comprising frame parts 19, interconnecting parts 20 and resilient suspension elements 21. The combination of the mask blank 15 and the frame 18 is referred to as mask box 22. The frame parts 19 and the interconnecting parts 20 may have many shapes, wherein it is important that a sufficiently solid frame 18 is obtained, and also that the upright edge 17 of the mask blank 15 can easily be attached to the frame 18.

FIG. 2 shows an embodiment of the mask box 22 provided with four resilient suspension elements 21. For the sake of clarity, only a few of the many apertures 16 in the mask blank 15 are shown. In this example, each resilient suspension element 21 is arranged in a corner of the frame 18, on an interconnecting part 20. Furthermore, each resilient suspension element 21 is shaped like a leaf spring which extends substantially perpendicularly to the electron beams deflected towards the relevant corner.

FIG. 3 shows another embodiment of the mask box 22 provided with three resilient suspension elements 21, wherein each resilient element 21 is arranged in a position along a frame part 19.

To preclude differences in expansion between the mask blank 15 and the frame 18, they are preferably both made of the same material and preferably have approximately the same thickness. Preferably, the mask blank 15 and the frame 18 are attached to one another by welding.

FIG. 4 is an exploded perspective view of a corner part of a panel-mask box combination 23, which is part of the color display tube 1 and comprises the panel 2 and the mask box 22, which is suspended from said panel 2.

A suspension pin 24 is arranged in a corner of the upright edge 6 of the panel 2. The suspension pin 24 comprises a suspension pin head 25 and a suspension pin base 26 having a supporting surface 27 for supporting the suspension pin head 25. Preferably, the suspension pin 24 is made of metal and is attached to the panel inner surface 7 by melting it in. The suspension pin head 25 as shown is spherical, yet the suspension pin head 25 may have many shapes. Preferably, the supporting surface 27 is flat. The suspension pin head 25 can be placed directly onto the supporting surface 27, but it is also possible for example to place a washer between the suspension pin head 25 and the supporting surface 27.

In the example shown, the resilient suspension element 21 is shaped like a leaf spring which springs about a spring axis 28. The resilient suspension element 21 comprises a base part 29 and a suspending part 30, the base part 29 being attached to the interconnecting part 20 of the frame 18 and the suspending part 30 being attached to the base part 29, for example by welding. The suspending part 30 comprises a receiving part 31, which is suitable for receiving the greater part of the suspension pin head 25. Thus, the mask box 22 is suspended from the panel 2 by making the receiving parts 31 of the resilient suspension elements 21 enclose the greater part of the suspension pin heads 25.

The suspension pin head 25 and the receiving part 31 may have many shapes, as long as the receiving part 31 is able to at least partially enclose the suspension pin head 25.

FIG. 5 is a sectional view taken on the line A-A of FIG. 4, showing a part of the panel-mask box combination 23 in an assembled condition. In this condition, the mask box 22 is suspended from the panel 2, the greater part of the suspension pin head 25 being enclosed by the receiving part 31 of the resilient suspension element 21.

As shown in FIG. 5, the resilient suspension element 21 is connected to the interconnecting part 20 of the frame 18 by means of a corner piece 32, one side. 33 of said corner piece 32 being attached to the base part 29 of the resilient suspension element 21 and another side 34 being attached to the front of the interconnecting part 20 of the frame 18, for example by welding.

In the following, a new method for providing a panel with suspension pins will be described on the basis of an example in which four suspension pins 24 are arranged in the corners of the panel 2. However, the new method can for example also be utilized for arranging three suspension pins 24 on the panel inner surface 7, and for preparing the panel 2 to cooperate with a mask box 22 having three resilient suspension elements 21, as shown in FIG. 3.

Referring to FIGS. 6 and 7, a panel 2 is placed on a panel positioning device 35, in a way which is known per se. The panel positioning device 35 comprises two fixed positioning points 36, 37, as diagrammatically shown in FIG. 6. In the example shown, the fixed positioning points 36, 37 support the panel 2 in positions close to opposite corners of the panel 2. Furthermore, the panel positioning device 35 comprises four pairs of adjustable positioning points. In every pair, the adjustable positioning points are able to make interrelated movements with respect to a central point. In positioning the panel 2, the adjustable positioning points of a pair are moved until they both come into contact with the surface of the panel 2 in a pre determined way, for example until they abut against opposite sides of the upright edge 6 of the panel 2. The panel 2 is in a pre-determined position then with respect to the central point of the pair.

A first pair of adjustable positioning points 38, 39 is shown in FIG. 6. In the example shown, the adjustable positioning points 38, 39 support the panel 2 in positions close to opposite corners of the panel 2, thereby positioning the panel 2 with respect to a central point 40.

A second pair of adjustable positioning points 41, 42 is shown in FIG. 7. In the example shown, the adjustable positioning points 41, 42 are able to position the panel 2 with respect to a central point 43 by contacting opposite sides of the panel 2.

A third pair of adjustable positioning points 44, 45 is also shown in FIG. 7. In the example shown, the adjustable positioning points 44, 45 are able to position the panel 2 with respect to a central point 46 by contacting opposite sides of the panel 2.

A fourth pair of adjustable positioning points 47, 48 is also shown in FIG. 7. In the example shown, the adjustable positioning points 47, 48 are able to position the panel 2 with respect to a central point 49 by contacting opposite sides of the panel 2.

It will be understood that the fixed positioning points 36, 37 and the central points 40, 43, 46, 49 constitute a complete system of six points which fixes all six degrees of freedom of the panel 2.

Furthermore, it will be understood that the panel positioning device 35 as shown in FIGS. 6 and 7 is just one example of the many possibilities with regard to the number and the position of the positioning points.

Once the panel is positioned on the panel positioning device 35, the panel positioning device 35 is preferably also utilized as a reference system for processing the panel 2, for example for providing the panel 2 with suspension pins 24.

In a first step of providing the panel 2 with suspension pins 24 suspension pin bases 26 are attached to the panel inner surface 7, for example by attaching the suspension pin bases 26 to the glass of the panel 2 by melting it in. In this example, the suspension pin bases 26 are provided in every corner of the panel 2. The positioning of the suspension pin bases 26 is performed with respect to the positioning points of the panel positioning device 35 onto which the panel 2 is placed. As already stated, the suspension pin bases 26 can be positioned with an accuracy of ±0.6 mm, in all directions.

Once the suspension pin bases 26 are attached to the panel inner surface 7, the suspension pin heads 25 can be placed onto the supporting surfaces 27 of the suspension pin bases 26. According to the present invention, the suspension pin heads 25 are then positioned with respect to the positioning points of the panel positioning device 35 prior to attaching the suspension pin heads 25 to the suspension pin bases 26.

The positioning of each suspension pin head 25 with respect to the positioning points of the panel positioning device 35 is performed on the basis of a presumed cooperation with a nominal resilient suspension element 21′, which is defined as a resilient suspension element 21 which is positioned nominally with regard to the positioning points and which springs according to a nominal spring characteristic. The nominal resilient suspension element 21′ comprises a nominal receiving part 31′, which is positioned nominally on the nominal resilient element 21′, i.e. which has a nominal position with respect to a nominal spring axis 28′ of the nominal resilient suspension element 21′. According to the present invention, the suspension pin head 25 is brought into a nominal receiving path, which is described by the nominal receiving part 31′, while being positioned on the supporting surface 27.

In the following, a tangential direction is similar to the direction in which the nominal spring axis 28′ extends; an axial direction is defined as the direction in which the supporting surface 27 extends, perpendicular to the tangential direction; and a radial direction is defined as the direction perpendicular to both the tangential direction and the axial direction. In FIGS. 8, 9 and 10, the axial direction is indicated by arrow a, the tangential direction is indicated by arrow t and the radial direction is indicated by arrow r.

In FIG. 8, a cross section of a portion of the panel 2 is shown. The suspension pin base 26 is attached to the panel 2 in a corner of said panel 2. The suspension pin head 25 is placed on the supporting surface 27. The tangential position of the suspension pin head 25 is such that the suspension pin head 25 is located in the nominal receiving path, which is indicated by dashed lines in FIG. 8.

In FIG. 9, a longitudinal section of a portion of the panel 2 is shown. The suspension pin base 26 is attached to the panel 2 at a certain distance from the display window 5. The suspension pin head 25 is placed on the supporting surface 27. The axial position of the suspension pin head 25 is such that the suspension pin head 25 is located in the nominal receiving path, which is indicated by dashed lines in FIG. 9. As can be clearly seen in FIG. 9, positioning the suspension pin head 25 in the nominal receiving path can result in positioning the suspension pin head 25 outside the center of the supporting surface 27. In fact, the axial positions of different suspension pin heads 25 can be different, since the axial position of each suspension pin head 25 is influenced by the radial position of the supporting surface 27.

The correlation between the axial position of the suspension pin head 25 and the radial position of the supporting surface 27 can be understood with the help of FIG. 10. In FIG. 10, a first possible supporting surface is indicated by reference numeral 27′, while a second possible supporting surface, which is located closer to the panel inner surface 7, is indicated by reference numeral 27″. The nominal receiving path is indicated by dashed lines, in a similar way as in FIG. 9. Despite the different radial positions of the supporting surfaces 27′, 27″, the suspension pin head 25 can be positioned in both situations on the supporting surface 27′, 27″ as well as in the nominal receiving path. As a result, the axial position of a suspension pin head 25′ which is positioned on the supporting surface 27′ differs from the axial position of a suspension pin head 25″ which is positioned on the supporting surface 27″. In this example, the suspension pin head 25″ is located closer to the display window 5 than the suspension pin head 25′.

If the above-described method according to the invention is applied, the suspension pin heads 25 are positioned nominally, enabling an accuracy of at least ±25 μm to be achieved for the positions of the suspension pin heads 25, in all directions. In the tangential direction, it is even possible to achieve an accuracy of ±10 μm.

In a first preferred way of carrying out the method for providing the panel 2 with suspension pins 24 according to the invention, the axial position of the suspension pin head 25 with respect to the positioning points is determined by measuring the radial position of the supporting surface 27 with respect to the positioning points after attaching the suspension pin base 26 to the panel 2. As possible combinations for radial and axial positions are known for the nominal receiving part 31′, the axial position of the suspension pin head 25 can be determined on the basis of the measuring result.

Referring to FIG. 11, in a second preferred way of carrying out the method for providing the panel 2 with suspension pins 24 according to the invention, a dummy mask box 50 is utilized, having substantially the same design as a mask box 22 which is to be suspended from a panel 2, wherein the resilient suspension elements 21 of the dummy mask box 50 can be regarded as nominal resilient suspension elements 21′. Each resilient suspension element 21′ comprises a hole 51 representing the nominal receiving part 31′. The dummy mask box 50 is positioned nominally with regard to the panel 2, and the suspension pin heads 25, which are to be attached to the suspension pin bases 26 on the panel inner surface 7, are placed inside the holes 51 and on the supporting surfaces 27. In the process, the suspension pin heads 25 are placed on the supporting surfaces 27 in a nominal position, since they are actually positioned in the nominal receiving path. The nominal positioning of the dummy mask box 50 can be performed in any suitable manner known from the state of the art, for example by utilizing at least one distance piece which is positioned between the panel inner surface 7 and the dummy mask box 50. Subsequent to placing the suspension pin heads 25 onto the supporting surfaces 27, the dummy mask box 50 is removed and the suspension pin heads 25 are attached to the suspension pin bases 26 by for example welding.

Preferably, subsequent to attaching the suspension pin heads 25 to the suspension pin bases 26, the obtained positions of the suspension pin heads 25 are measured with respect to the positioning points in order to check whether a prescribed positioning accuracy of the suspension pin heads 25 is achieved.

As a result of the very accurate positioning of the suspension pin heads 25, it is possible to utilize one and the same panel 2 for manufacturing a series of mask boxes 22. Preferably, a mask box positioning device representative of the panel 2 is utilized. Said mask box positioning device comprises dummy suspension pin heads corresponding to the suspension pin heads 25 of the panel 2, which is represented.

By using the mask box positioning device, the mask box 22 is manufactured in a way which is known per se. At the start of the manufacturing process, a frame 18 is placed onto the mask box positioning device, the frame parts 19 being positioned with respect to the dummy suspension pin heads. At this stage, the suspending parts 30 of the resilient suspension elements 21 are slidable with regard to the base parts 29, so that the positions of the receiving parts 31 can be perfectly adapted to the positions of the dummy suspension pin heads. After the receiving parts 31 have been properly positioned, the suspending parts 30 are fixed with respect to the base parts 29, preferably by welding. The frame 18 is then suitable for use in any panel 2 represented by the mask box positioning device. Since the positions of the receiving parts 31 are perfectly adapted to the positions of the dummy suspension pin heads, the frame 18 is stress-free, which is very advantageous regarding the insertion reproducibility of the mask box 22 in which the frame 18 is to be utilized.

Furthermore, a mask blank 15 is positioned nominally with regard to the dummy suspension pin heads, the nominal position being derived from a nominal contour of the display window 5, a nominal contour of the mask blank 15 itself, and a nominal window to mask distance. Then the mask blank 15 is attached to the frame 18, preferably by welding. At that stage, the mask box 22 is ready and suitable for use in any panel 2 represented by the mask box positioning device. In this way, it is possible to manufacture a series of panel-mask box combinations 23 by combining any mask box 22 which is manufactured using the mask box positioning device with any panel 2 which is represented by the same mask box positioning device. Only after the photographic process has started, a specific panel 2 and a specific mask box 22 have to be kept together, due to the fact that the photographic process must be performed with extreme accuracy.

The positioning of the frame parts 19 and the mask blank 15 with respect to the dummy suspension pin heads of the mask box positioning device can be performed in any suitable manner known from the state of the art, for example by utilizing at least one distance piece. Also, the mask box positioning device can comprise more positioning points than just the dummy suspension pin heads.

Summarizing, the present invention relates to a method for providing a glass panel 2 of a color display tube with suspension pins 24 for suspending a mask box 22 in a nominal position from said panel 2, the mask box 22 comprising resilient suspension elements 21. Firstly, suspension pin bases 26 are positioned on an inner surface 7 of the panel 2 and subsequently attached the panel inner surface 7 by melting them in. Secondly, suspension pin heads 25 are positioned on the suspension pin bases 26 and subsequently attached to the suspension pin bases 26. In the process, the positioning of the suspension pin bases 26 as well as of the suspension pin heads 25 is performed with respect to a panel positioning device 35 comprising positioning points 36; 37; 38, 39; 41, 42; 44, 45; 47, 48. In particular, the suspension pin heads 25 are brought into a nominal receiving path which is described by a nominal receiving part 31′ of a nominal resilient suspension element 21′.

It will be clear to a person skilled in the art that the scope of the present invention is not limited to the examples discussed in the foregoing, but that several amendments and modifications thereof are possible without deviating from the scope of the invention as defined in the appended claims.

1. Method for providing a glass panel (2) of a color display tube (1) with suspension pins (24) for suspending a mask box (22) in a nominal position from said panel (2), the suspension pins (24) comprising:
a suspension pin head (25) which is suitable for being at least partly received by a receiving part (31) of a resilient suspension element (21) of the mask box (22) to be suspended; and
a suspension pin base (26) for connecting the suspension pin head (25) to an inner surface (7) of the panel, the suspension pin base (26) having a supporting surface (27) for supporting the suspension pin head (25);
the method comprising the following steps:
placing the panel (2) onto a panel positioning device (35) comprising positioning points (36; 37; 38, 39; 41, 42; 44, 45; 47, 48);
positioning at least three suspension pin bases (26) nominally with respect to the positioning points (36; 37; 38, 39; 41, 42; 44, 45; 47, 48);
attaching the suspension pin bases (26) to the panel inner surface (7);
placing the suspension pin heads (25) onto the supporting surfaces (27) of the suspension pin bases (26); and
attaching the suspension pin heads (25) to the suspension pin bases (26);
characterized in that the suspension pin heads (25) are positioned nominally with respect to the positioning points (36; 37; 38, 39; 41, 42; 44, 45; 47, 48).

2. Method according to claim 1, characterized by bringing each suspension pin head (25) into a nominal receiving path which is described by a nominal receiving part (31′) of a nominal resilient suspension element (21′).

3. Method according to claim 2, characterized by bringing each suspension pin head (25) into the nominal receiving path by first bringing the suspension pin head (25) into a tangential position, which is determined by the tangential position of the nominal receiving path, and subsequently into an axial position, which is determined by the possible combinations of axial positions and radial positions of the nominal receiving path as well as the radial position of the supporting surface (27).

4. Method according to claim 3, characterized by measuring the radial positions of the supporting surfaces (27) with respect to the positioning points (36; 37; 38, 39; 41, 42; 44, 45; 47, 48) subsequent to attaching the suspension pin bases (26) to the panel inner surface (7), in order to determine the axial positions with respect to the positioning points (36; 37; 38, 39; 41, 42; 44, 45; 47, 48) into which the suspension pin heads (25) must be brought.

5. Method according to claim 2, characterized in that a dummy mask box (50) is utilized for bringing each suspension pin head (25) into the nominal receiving path, the resilient suspension elements (21) of the dummy mask box (50) comprising holes (51) for receiving the suspension pin heads (25), the method comprising the following steps:
bringing the dummy mask box (50) into a nominal position with respect to the positioning points (36; 37; 38, 39; 41, 42; 44, 45; 47, 48);
placing the suspension pin heads (25) inside the holes (51) and onto the supporting surfaces (27); and
attaching the suspension pin heads (25) to the suspension pin bases (26).

6. Method according to claim 5, characterized in that at least one distance piece is utilized for bringing the dummy mask box (50) into the nominal position with respect to the positioning points (36; 37; 38, 39; 41, 42; 44, 45; 47, 48).

7. Method according to claim 1, characterized in that the positions of the suspension pin heads (25) are measured with respect to the positioning points (36; 37; 38, 39; 41, 42; 44, 45; 47, 48) subsequent to attaching the suspension pin heads (25) to the suspension pin bases (26).

8. Method for positioning a suspension pin head (25) onto a suspension pin base (26) attached to an inner surface (7) of a glass panel (2) which is placed onto a panel positioning device (35) comprising positioning points (36; 37; 38, 39; 41, 42; 44, 45; 47, 48), said method comprising the step of placing the suspension pin head (25) onto a supporting surface (27) of the suspension pin base (26), characterized in that the suspension pin head (25) is positioned nominally with regard to the positioning points (36; 37; 38, 39; 41, 42; 44, 45; 47, 48).

9. Method for manufacturing a series of at least two substantially identical mask boxes (22) which are to be suspended in a nominal position from a glass panel (2) having a display window (5), each of the mask boxes (22) comprising:
a frame (18) comprising at least three resilient suspension elements (21) having a base part (29) and a receiving part (31) for at least partly receiving a suspension pin head (25) of a suspension pin (24) arranged on an inner surface (7) of the panel (2), the receiving part (31) being slidable with regard to the base part (29) and frame parts (19), each frame part (19) interconnecting two resilient suspension elements (21); and
a mask blank (15);
the method of manufacturing each of the mask boxes (22) comprising the following steps:
positioning the frame (18) with respect to a mask box positioning device comprising positioning points, wherein at least three positioning points comprise dummy suspension pin heads for cooperating with the receiving parts (31) of the resilient suspension elements (21);
fixing the receiving parts (31) with respect to the base parts (29) of the resilient suspension elements (21);
bringing the mask blank (15) into a nominal position with respect to the positioning points; and
attaching the mask blank (15) to the frame (18);
wherein for manufacturing the series of mask boxes (22) one and the same mask box positioning device is utilized.

10. Method according to claim 9, characterized in that at least one distance piece is utilized for positioning the frame (18) with respect to the positioning points.

11. Method according to claim 9, characterized in that at least one distance piece is utilized for bringing the mask blank (15) into the nominal position with respect to the positioning points.

12. Method for manufacturing a series of at least two panel-mask box combinations (23), comprising the following steps:
providing a series of at least two glass panels (2) with suspension pins (24) utilizing the method according to claim 1;
manufacturing a series of at least two mask boxes (22) utilizing the method according to any one of claims 9-11;
making panel-mask box combinations (23) by suspending any mask box (22) of the series of mask boxes (22) from any glass panel (2) of the series of glass panels (2).

13. Dummy mask box (50), comprising at least three resilient suspension elements (21′), characterized in that each resilient suspension element (21′) comprises a hole (51) representing a nominal receiving part (31′).
